(19) United States
(12) Patent Application Publication
(10) Pub. No.: US 2025/0094849 A1
(43) Pub. Date: Mar. 20, 2025

(54) QUBIT MAPPING METHOD AND APPARATUS, DEVICE, AND STORAGE MEDIUM

(71) Applicant: Tencent Technology (Shenzhen) Company Limited, Shenzhen (CN)

(72) Inventors: Pei YUAN, Shenzhen (CN); Shengyu ZHANG, Shenzhen (CN)

(21) Appl. No.: 18/767,831

(22) Filed: Jul. 9, 2024

Related U.S. Application Data
(63) Continuation of application No. PCT/CN2023/130181, filed on Nov. 7, 2023.

(30) Foreign Application Priority Data
Sep. 15, 2023 (CN) 202311200317.5

(51) Int. Cl. G06N 10/20

(52) U.S. Cl. CPC G06N 10/20

(57) ABSTRACT

A qubit mapping method is performed by a computer device. The method includes: obtaining a coupling graph corresponding to a quantum device, each vertex in the coupling graph representing one qubit in the quantum device, an edge between two vertexes representing that a two-qubit gate is allowed to directly act on qubits corresponding to the two vertexes; generating at least two connected subgraphs based on the coupling graph, a quantity of vertexes of each connected subgraph being greater than or equal to 2 and less than or equal to a routing number of the coupling graph, and a sum of quantities of vertexes of the at least two connected subgraphs being equal to a constant multiple of a quantity of vertexes of the coupling graph; and performing qubit mapping on a logic circuit based on the at least two connected subgraphs, to obtain a corresponding hardware compilable circuit.

### CROSS-REFERENCE TO RELATED APPLICATIONS

This application is a continuation application of PCT Patent Application No. PCT/CN2023/130181, entitled “QUBIT MAPPING METHOD AND APPARATUS, DEVICE, AND STORAGE MEDIUM” filed on Nov. 7, 2023, which claims priority to Chinese Patent Application No. 202311200317.5, entitled “QUBIT MAPPING METHOD AND APPARATUS, DEVICE, AND STORAGE MEDIUM” filed on Sep. 15, 2023, both of which are incorporated herein by reference in their entirety.

### FIELD OF THE TECHNOLOGY

This application relates to the field of quantum technologies, and in particular, to a qubit mapping method and apparatus, a device, and a storage medium.

### BACKGROUND OF THE DISCLOSURE

Research of a qubit mapping method is very important for implementing a quantum algorithm and improve performance of a quantum computer. This is also one of key problems in current quantum computing research.

When the qubit mapping method is researched, using an optimization problem-based method refers to reducing a qubit mapping problem to an equivalent mathematical optimization problem, and resolving the qubit mapping problem by using an existing optimization problem solver. Specifically, a mathematical model needs to be first created, and various constraints and an objective function in the qubit mapping problem are converted into constraint conditions and an objective function in the optimization problem. When the model is created, it needs to be ensured that the original problem is equivalent to the converted optimization problem, to ensure that an obtained solution to the optimization problem is a feasible solution to the original mapping problem. Then, an existing solving algorithm and a program package are selected based on a type of the optimization problem, for example, linear programming, quadratic programming, and a semi-definite programming solver. The created mathematical model is inputted into the solver, and through iterative calculation by the solver, a solution that meets the constraint condition and that causes the objective function to reach an optimal value can be finally obtained. Finally, the optimized solution given by the solver is mapped back to solution space of the qubit mapping problem, so that the feasible solution to the original mapping problem is obtained.

In the related art, qubit mapping is performed by using the optimization problem-based method, causing a problem of high time complexity.

### SUMMARY

Embodiments of this application provide a qubit mapping method and apparatus, a device, and a storage medium. The technical solutions provided in the embodiments of this application are as follows:

According to an aspect of the embodiments of this application, a qubit mapping method is performed by a computer device, and the method includes:
obtaining a coupling graph corresponding to a quantum device, each vertex in the coupling graph representing one qubit in the quantum device, an edge between two vertexes representing that a two-qubit gate is allowed to directly act on qubits corresponding to the two vertexes;
generating at least two connected subgraphs based on the coupling graph, a quantity of vertexes of each connected subgraph being greater than or equal to 2 and less than or equal to a routing number of the coupling graph, a sum of quantities of vertexes of the at least two connected subgraphs being equal to a constant multiple of a quantity of vertexes of the coupling graph, and the routing number of the coupling graph being a maximum quantity of permutation rounds of all permutations on the coupling graph; and
performing qubit mapping on a logic circuit based on the at least two connected subgraphs, to obtain a hardware compilable circuit equivalent to the logic circuit.

According to an aspect of the embodiments of this application, a computer device is provided, including a processor and a memory, the memory having a computer program stored therein, the computer program being loaded and executed by the processor, to implement the foregoing qubit mapping method.

According to an aspect of the embodiments of this application, a non-transitory computer-readable storage medium is provided, the storage medium having a computer program stored therein, the computer program being loaded and executed by a processor, to implement the foregoing qubit mapping method.

The technical solutions provided in the embodiments of this application have at least the following beneficial effects:

The coupling graph is segmented into the at least two connected subgraphs, a qubit permutation originally performed under a limit of the entire coupling graph is converted into a qubit permutation performed on the plurality of connected subgraphs, to resolve a problem of an excessively large depth caused by the qubit permutation under the limit of the coupling graph, thereby controlling the circuit depth of the hardware compilable circuit, and achieving a technical effect of effectively reducing time complexity of the qubit mapping.

### BRIEF DESCRIPTION OF THE DRAWINGS

To describe the technical solutions in embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a flowchart of a qubit mapping method according to an embodiment of this application.

FIG. 2 is a schematic diagram of two coupling graphs corresponding to a superconducting quantum device according to an embodiment of this application.

FIG. 3 is a schematic diagram of calculation of a routing number of a common connected graph according to an embodiment of this application.

FIG. 4 is a schematic diagram of pseudocode of a graph algorithm according to an embodiment of this application.

FIG. 5 is a schematic diagram of an instance of a graph algorithm according to an embodiment of this application.

FIG. 6 is a schematic diagram of a quantity of quantum circuit layers according to an embodiment of this application.

FIG. 7 is a schematic diagram of construction of a hardware compilable circuit according to an embodiment of this application.

FIG. 8 is a block diagram of a qubit mapping apparatus according to an embodiment of this application.

FIG. 9 is a block diagram of a structure of a computer device according to an embodiment of this application.

### DESCRIPTION OF EMBODIMENTS

To make the objectives, technical solutions, and advantages of this application clearer, the following further describes the implementations of this application in detail with reference to the accompanying drawings.

Before the technical solutions of this application are described in detail, concepts involved in this application are first defined and described.

(1) Quantum circuit: The quantum circuit is a quantum computing model formed by a series of quantum gates and a measurement sequence, and computation is completed by the quantum gates.

(2) Qubit: The qubit is a basic unit of quantum computing. A conventional computer uses 0 and 1 as basic units of binary. Different from the conventional computer, both 0 and 1 may be processed through quantum computing, and a system may be in a linear superposition state of 0 and 1: |ψ [symbol] =α|0 [symbol] +β|1 [symbol] , where α β represent complex probability amplitudes of the system at 0 and 1. Modulo squares |α|², |β|² of α, β represent probabilities at 0 and 1 respectively.

(3) Coupling graph: In the coupling graph, qubits are used as vertexes and coupling relationships between the qubits are used as edges, and a graph model for representing a mutual coupling relationship between the qubits is formed. If vertexes corresponding to two qubits are connected by an edge in the coupling graph, it indicates that a two-qubit gate operation may be directly performed on this qubit pair, while a swap gate operation needs to be first performed on a qubit pair that is not directly connected, to swap states of the two qubits, and then the two-qubit gate operation is performed on the two qubits.

(4) Qubit mapping: For any coupling graph G=(V,E), a vertex set V represents a qubit set. If in a quantum circuit, any two-qubit gate acting on a qubit u, w∈V meets (u, w)∈E, the quantum circuit is referred to as a hardware compilable circuit.

(5) Qubit mapping problem: Any coupling graph G and any logic circuit C are given, and a hardware compilable circuit C′ equivalent to the logic circuit is obtained only by inserting a swap gate.

(6) Routing on graphs: A coupling graph G=(V,E) is given, there is an element on each vertex, and the following uses an example in which the element is a stone. The routing on graphs refers to a process as follows: for any permutation π∈S_{V}, a stone on each vertex v∈V is moved to π(v). In an i^{th} round, there is one matching Mᵢ⊆E, and if (u, v)∈Mᵢ, two stones on vertexes u, v are allowed to be swapped. rt(G, π) represents a minimum quantity of rounds required to move all stones from their initial positions v to target positions π(v). A routing number of the graph G is defined as:

$$rt ( G ) = {max}_{π ∈ {S}_{V}} rt ( G , π )$$

In other words, the routing number of the graph is equal to a maximum quantity of permutation rounds in consideration of all permutations of the graph. The quantity of rounds refers to a quantity of rounds of permutation required to move the stone on each vertex v∈V to π(v).

(7) Basic symbol: [n] represents an integer set {1,2, . . . , n}. For a set V₁ and a set V₂, V₁\V₂:={a: a∈V₁ and a∉V₂}, where a symbol \ represents a difference set, and V₁\V₂ represents a set of vertexes that belong to the set V₁ but do not belong to the set V₂. For a graph G=(V,E), V and E represent a vertex set and an edge set of the graph G respectively. For the graph G=(V,E) and a set V′⊂V, it is defined that an edge set E′:={(u, v): ∀u, v∈V′ and (u, v)∈E}, and the graph G′=(V′, E′) is referred to as a subgraph that is of G and that is generated by V′. For any set V whose size is n, S_{V} represents a set formed by all permutations defined on V. For a set S, |S| represents a size of the set.

(8) Worst additional depth: Assume that G=(V,E) represents a coupling graph including n vertexes, Kₙ represents a complete graph including n vertexes, Cₙ represents an n-qubit logic circuit, that is, represents a qubit logic circuit including n vertexes in the graph G. The worst additional depth on the coupling graph G is defined as:

$$𝔇 ( G ) = {max}_{{C}_{n}} \frac{d ( {C}_{n} , G )}{d ( {C}_{n} , {K}_{n} )}$$

where d(Cₙ, G) represents a minimum depth of a hardware compilable circuit corresponding to Cₙ under the limit of the coupling graph G, and d(Cₙ, Kₙ) represents a circuit depth of the logic circuit Cₙ.

In the qubit mapping method provided in the embodiments of this application, an execution entity of all operations may be a computer device, and the computer device may be any electronic device having a computing capability and a storage capability. For example, the computer device may be an electronic device such as a personal computer (PC) or a server.

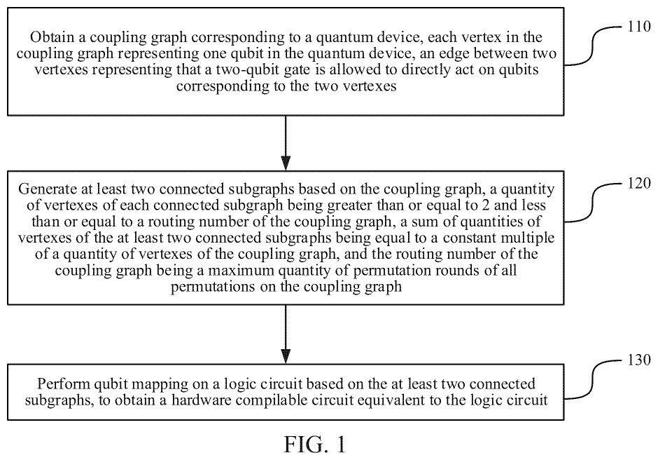

FIG. 1 is a flowchart of a qubit mapping method according to an embodiment of this application. An execution entity of operations of the method may be a computer device. The method may include at least one of the following operations 110 to 130.

Operation 110: Obtain a coupling graph corresponding to a quantum device, each vertex in the coupling graph representing one qubit in the quantum device, an edge between two vertexes representing that a two-qubit gate is allowed to directly act on qubits corresponding the two vertexes.

The quantum device is a device implemented by using a quantum physical effect, and is configured to implement functions such as accelerated computing, communication, and detection. A qubit is a basic unit of the quantum device. A coupling relationship between a plurality of qubits in the quantum device may be represented in a form of a graph, and the graph may be referred to as the coupling graph. In other words, the coupling graph abstractly presents an interaction relationship between the qubits at a physical level in the quantum device.

In some embodiments, the coupling graph in this application is a connected graph. Because connectivity of the coupling graph corresponding to the quantum device depends on a design objective and a physical implementation of the quantum device, the coupling graph corresponding to the quantum device may be disconnected. The connectivity refers to whether there is a path connecting any two vertexes. Because this application studies a qubit mapping problem of any logic circuit, the study includes a two-qubit gate acting on any qubit pair. This requires that the coupling graph is at least connected. Therefore, in this application, the coupling graph is the connected graph by default.

In the coupling graph, a vertex represents a qubit in the quantum device, and an edge represents that a two-qubit gate may act on two qubits connected by the edge. The two-qubit gate is a quantum gate acting on two qubits and is configured to implement a logic operation and interaction between the qubits. The two-qubit gate includes but is not limited to: a controlled NOT (CNOT) gate, a swap (SWAP) gate, a square root of swap (SQSWAP) gate, a controlled Z (CZ) gate, a controlled rotation (CR) gate, an interaction swap (ISWAP) gate, and the like.

In a possible implementation, a coupling graph corresponding to any quantum device is obtained through a design drawing or a document, or an interaction relationship between different qubits may be experimentally measured to obtain a coupling graph corresponding to any quantum device. This is not limited in this application.

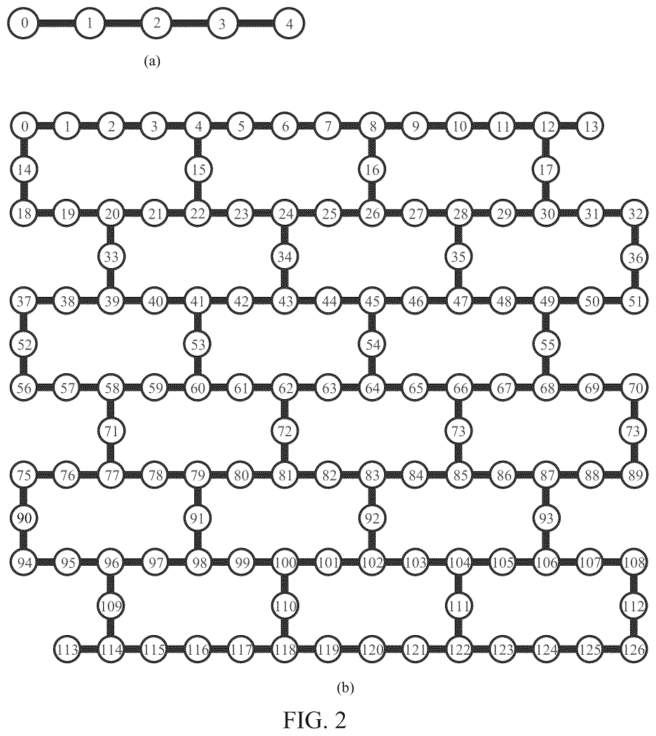

FIG. 2 is a schematic diagram of two coupling graphs corresponding to a superconducting quantum device according to an embodiment of this application. A subgraph (a) is a path graph, and a subgraph (b) is a brick wall graph. A vertex represents a qubit in the quantum device. If two vertexes are connected by an edge, it indicates that a two-qubit gate may directly act on qubits corresponding to the two vertexes. In a logic circuit, two logic bits corresponding to any two-qubit gate may not be connected by an edge in a coupling graph, that is, the two-qubit gate cannot be directly implemented on a quantum device. For example, referring to the subgraph (b) of FIG. 2, if a two-qubit gate, for example, a CNOT gate, is to be implemented between two qubits 0 and 18, because the two qubits 0 and 18 are not directly connected, the two-qubit gate cannot be directly implemented. For example, referring to the subgraph (b) of FIG. 2, if a two-qubit gate, for example, a CNOT gate, is to be implemented between two qubits 0 and 1, because the two qubits 0 and 1 are directly connected, the two-qubit gate can be directly implemented on the qubit pair 0 and 1.

Operation 120: Generate at least two connected subgraphs based on the coupling graph, a quantity of vertexes of each connected subgraph being greater than or equal to 2 and less than or equal to a routing number of the coupling graph, a sum of quantities of vertexes of the at least two connected subgraphs being equal to a constant multiple of a quantity of vertexes of the coupling graph, and the routing number of the coupling graph being a maximum quantity of permutation rounds of all permutations on the coupling graph.

The permutation refers to moving an element on a vertex of the coupling graph from an initial vertex position to a target vertex position, and there is an element on each vertex of the coupling graph, where the initial vertex position refers to a vertex position at which the element is currently located, the target vertex position refers to a vertex position where the element wants to reach, and the initial vertex position and the target vertex position are not at a same vertex position. A mark of the element is not limited in this application. For example, a permutation 1→2 refers to swapping a position of an element on a vertex 1 with a position of an element on a vertex 2. For the element on the vertex 1, an initial vertex position is a position of the vertex 1, and a target vertex position is a position of the vertex 2. A permutation may include moving some or all elements from initial vertex positions to target vertex positions. This is not limited in this application.

For a coupling graph G=(V,E), if a subgraph H of G meets: A vertex set of H is a subset of V, and an edge set of H is a subset of E; and H is connected, that is, there is always a path connecting any two vertexes in H, the subgraph H is referred to as a connected subgraph of the graph G.

A routing number of the coupling graph G is denoted as

$$rt ( G ) = {max}_{π ∈ {S}_{V}} rt ( G , π ) ,$$

where rt(G, π) represents a routing number for performing a specific permutation π in the graph G, and rt(G) represents a maximum value of routing numbers for performing all permutations in the graph G. For specific content, refer to the foregoing definition of the routing number. The following describes some specific examples.

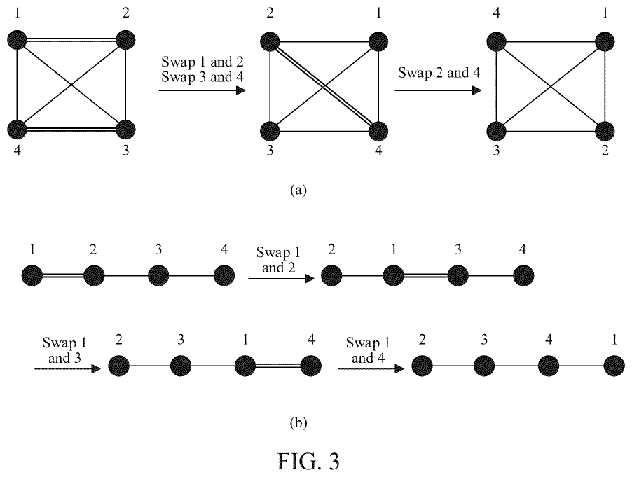

FIG. 3 is a schematic diagram of calculation of a routing number of a common connected graph according to an embodiment of this application. For example, as shown in a subgraph (a), a permutation π₁ is performed on a complete graph K₄ having four vertexes: 1→2, 2→3, 3→4, 4→1. The permutation operations are as follows: in a first round, 1 and 2 are swapped, and 3 and 4 are swapped, and in a second round, 2 and 4 are swapped. A total of two rounds are required, so that rt(K₄, π₁)=2.

For example, as shown in a subgraph (b), a permutation π₂ is performed on a path graph P₄: 1→2, 2→3, 3→4, 4→1. The permutation operations are as follows: in a first round, 1 and 2 are swapped, in a second round, 1 and 3 are swapped, and in a third round, 1 and 4 are swapped. A total of three rounds are required, so that rt(P₄, π₂)=3. Actually, any rt(G, π) corresponds to a permutation algorithm for π. For example, in the complete graph K₄, the permutation operations of swapping 1 and 2 and swapping 3 and 4, and the like for the permutation π₁ are implemented by using the permutation algorithm. For more content about the permutation algorithm, refer to the following descriptions.

In some embodiments, routing numbers of different connected graphs may be different. For a complete graph Kₙ having n vertexes, a routing number of the complete graph is rt(Kₙ)=2. For a path graph Pₙ whose length is n, a routing number of the path graph is rt(Pₙ)=O(n). O(n) describes an asymptotic upper bound of rt(Pₙ), that is, there is a positive number c to enable all rt(Pₙ)≤cn, and a symbol O has a similar meaning below. For a two-dimensional grid Gridₙ_{₁}_{,n}_{₂} whose size is n₁×n₂, a routing number of the two-dimensional grid is rt(Gridₙ_{₁}_{,n}_{₂})=O(n₁+n₂). For a tree Tₙ having n vertexes, a routing number of the tree is rt(Tₙ)=O(n).

In some embodiments, for a connected graph G=(V,E), an upper bound of a routing number of the connected graph is O(|V|). This is because, as described above, for the tree Tₙ having the n vertexes, the routing number of the tree is rt(Tₙ)=O(n). However, any connected graph G corresponds to a spanning tree. Because the spanning tree includes all vertexes of the graph G, rt(G)=O(|V|). In other words, the routing number of the connected graph is at most a constant multiple of a quantity of vertexes of the connected graph.

In some embodiments, a lower bound of the routing number of the graph is Ω(|V₁|/|V₂|), that is, there is a positive number c, to enable all rt(G)≥c(|V₁|/|V₂|), which reflects an asymptotic relationship between rt(G) and a point set size ratio |V₁|/|V₂|. The lower bound of the routing number is Ω(|V₁|/|V₂|), a proof process is as follows: for a connected graph G=(V,E), it is assumed that there are two vertex sets V₁, V₂⊆V meeting: V₁∩V₂=Ø; for any u∈V₁, N(u)⊆V₂, where N(u):={w∈V:∀(w,u)∈E}, that is, N(u) represents a set of vertexes in the graph G that are directly connected to vertexes in the set V₁. Stones in the vertex set V₁ are respectively denoted as 1,2, . . . , |V₁|. It is defined that s:=└|V₁|/2┘ and a permutation π:=(1, 1+s)(2, 2+s) . . . (s, 2s). In the graph G, the permutation π is performed, that is, a stone i is moved to a vertex on which a stone i+s is located. Because for any u∈V₁ and N(u)⊆V₂, the stone i needs to pass through vertexes in the set V₂ to reach the vertex on which the stone i+s is located. In one round, at most |V₂| stones in V₁ can pass through V₂, so that it takes at least ┌s/|V₂|┐ rounds to move s stones, where ┌s/|V₂|┐ represents rounding up a ratio of s/|V₂|. Therefore, rt(G)≥rt(G, π)≥┌s/|V₂|┐=Ω(|V₁|/|V₂|).

In some embodiments, a quantity of vertexes of each connected subgraph is limited: the quantity of vertexes of each connected subgraph is greater than or equal to 2 and less than or equal to the routing number of the coupling graph, to ensure that each connected subgraph has at least two qubits and ensure that mapping complexity of each connected subgraph is controlled. In addition, quantities of vertexes of all connected subgraphs cover a constant multiple of vertex sets of the coupling graph. The constant refers to a positive number herein, and may be preset based on an actual situation, for example, the constant may be set to 2. Therefore, a plurality of generated connected subgraphs both meet a specific scale limit and implement coverage of most or even all of the vertexes of the coupling graph, thereby providing an advantage condition for subsequent qubit mapping.

Operation 130: Perform qubit mapping on a logic circuit based on the at least two connected subgraphs, to obtain a hardware compilable circuit equivalent to the logic circuit.

The logic circuit herein refers to a quantum circuit corresponding to a quantum algorithm that a user wants to implement. The quantum algorithm implements an algorithm task by designing a quantum gate of the quantum circuit. When a quantum circuit corresponding to any logic circuit is implemented on a quantum device, the quantum circuit is limited by a coupling graph corresponding to the quantum device. If the quantum circuit has a two-qubit gate acting on two qubits, and the two qubits are not directly connected in the coupling graph, the quantum circuit is not a hardware compilable circuit.

However, in practice, the quantum circuit corresponding to the quantum algorithm that the user wants to implement is usually not a hardware compilable circuit. To implement any logic circuit, a swap gate may be inserted, and the swap gate may swap quantum states of two qubits on which the swap gate acts, so that an interaction order between the qubits is changed, to obtain a hardware compilable circuit equivalent to the logic circuit. Therefore, studying how to perform qubit mapping on any logic circuit through insertion of a swap gate to obtain an equivalent hardware compilable circuit is a so-called qubit mapping problem.

Referring to FIG. 2, if the two-qubit gate is to be implemented between the qubit 0 and the qubit 18, because the two-qubit gate cannot directly act on the qubit 0 and the qubit 18, a swap gate is introduced to obtain a hardware compilable circuit equivalent to the logic circuit. In a possible implementation, quantum states of the qubit 0 and a qubit 14 are first swapped through the swap gate. In this way, the qubit 0 and the qubit 18 are adjacent, and the required two-qubit gate may be implemented between the qubit 0 and the qubit 18. For example, a CNOT gate is implemented and may be performed by using the qubit 0 as a control bit and using the qubit 18 as a target bit. In this case, there is one swap gate and one CNOT gate acting in the hardware compilable circuit, and the swap gate and the CNOT gate are performed sequentially. A circuit depth of the hardware compilable circuit may be 2.

In some embodiments, a hardware compilable circuit equivalent to any logic circuit is not unique, and a corresponding circuit depth may be different. Referring to FIG. 2, if the two-qubit gate is to be implemented between the qubit 0 and the qubit 18, in another possible implementation, quantum states of the qubit 0 and a qubit 1 are first swapped through a swap gate. In this way, the qubit 0 and a qubit 2 are adjacent, and quantum states of the qubit 0 and the qubit 2 are swapped. In this way, the qubit 0 and a qubit 3 are adjacent, and quantum states of the qubit 0 and the qubit 3 are swapped. In this way, the qubit 0 and a qubit 4 are adjacent, and the swap gate is continuously used, so that the qubit 0 is successively swapped to vertexes on which qubits 4, 15, 22, 21, 20, and 19 are located. In this way, the qubit 0 and the qubit 18 are adjacent, and the required two-qubit gate may be implemented between the qubit 0 and the qubit 18. For example, the CNOT gate is implemented and may be performed by using the qubit 0 as a control bit and using the qubit 18 as a target bit. In this case, there are nine swap gates and one CNOT gate acting in the hardware compilable circuit, and the swap gates and the CNOT gate are performed sequentially. A circuit depth of the hardware compilable circuit may be 10.

When the qubit mapping problem is studied, the circuit depth reflects time complexity of the quantum algorithm, that is, a quantity of execution times of quantum gate operations. Therefore, when the hardware compilable circuit equivalent to the logic circuit is designed, time complexity of the quantum algorithm can be reduced by optimizing the circuit depth, and a speed and efficiency of quantum computing can be improved.

In some embodiments, based on the at least two connected subgraphs, if a qubit pair on which a two-qubit gate acts in the logic circuit is in a same connected subgraph, a permutation between qubits may be performed inside the connected subgraph to complete qubit mapping of the logic circuit. If the qubit pair on which the two-qubit gate acts in the logic circuit is not in the same connected subgraph, a partial permutation inside the connected subgraph may be first used to help reduce a distance of the qubit pair, and then the qubit mapping of the logic circuit is completed through global adjustment, to obtain the hardware compilable circuit equivalent to the logic circuit.

In this process, the connected subgraph ensures that distances of qubit pairs on which all two-qubit gates acts are not too far away after a constant quantity of permutations are performed on the qubit pairs. A circuit depth corresponding to each qubit pair permutation process is equal to a routing number of the graph after a permutation.

In the technical solutions provided in the embodiments of this application, the coupling graph is segmented into the at least two connected subgraphs, qubit permutation originally performed under a limit of the entire coupling graph is converted into qubit permutation performed on a plurality of connected subgraphs, to resolve a problem of an excessively large depth brought by the qubit permutation under the limit of the coupling graph, thereby controlling the circuit depth of the hardware compilable circuit, and achieving a technical effect of effectively reducing the time complexity of the qubit mapping.

The following describes a process of generating the at least two connected subgraphs based on the coupling graph.

In some embodiments, a first vertex set family and a second vertex set family are generated based on the coupling graph, where the first vertex set family includes at least one vertex set, the second vertex set family includes at least one vertex set, and each vertex set includes at least two vertexes in the coupling graph. After the first vertex set family and the second vertex set family are obtained, a connected subgraph corresponding to each vertex set in the first vertex set family and the second vertex set family is generated, to obtain at least two connected subgraphs.

The first vertex set family and the second vertex set family meet the following conditions: a subgraph corresponding to each vertex set in the first vertex set family and the second vertex set family is a connected graph; same vertexes do not exist in any two vertex sets in the first vertex set family, and same vertexes do not exist in any two vertex sets in the second vertex set family; a quantity of vertexes in each vertex set in the first vertex set family and the second vertex set family is greater than or equal to 2 and less than or equal to the routing number of the coupling graph; and a total quantity of vertexes in the first vertex set family and the second vertex set family is equal to a constant multiple of the quantity of vertexes of the coupling graph.

A set family refers to a set including elements that are vertex sets formed by some vertexes of the coupling graph. A vertex set family is limited. Because the two-qubit gate describes an effect or a correlation between two qubits, if subgraphs are not connected, a two-qubit gate defined between the subgraphs has no practical meaning. Therefore, a subgraph corresponding to each vertex set is a connected graph. To allow subgraphs to be mapped in parallel without mapping conflict and to improve a degree of concurrency, same vertexes do not exist in any two vertex sets in each set family.

In the foregoing method, a subgraph vertex set that meets a specific constraint condition is first generated, and then a corresponding connected subgraph is constructed, to provide a basis for subsequent qubit mapping of a logic circuit.

In some embodiments, the operation of generating a first vertex set family and a second vertex set family based on the coupling graph includes: first constructing maximum matching of the coupling graph, the maximum matching including at least one edge of the coupling graph; then generating the first vertex set family based on the maximum matching, each vertex set in the first vertex set family corresponding to two vertexes connected by an edge included in the maximum matching; denoting the first vertex set family as [symbol] and denoting the vertex set as Wᵢ, where i is an integer not greater than a quantity of edges of the maximum matching; and generating the second vertex set family based on the first vertex set family.

Matching of a graph refers to a subset of an edge in the graph, where any two edges do not share a common vertex, and maximum matching of the graph refers to matching including a maximum quantity of edges. An algorithm for constructing the maximum matching of the graph includes but is not limited to a Hungarian algorithm, a Kuhn-Munkres (Hungarian matrix matching) algorithm, an Edmonds algorithm, a streaming algorithm, and the like. In a possible implementation, the Hungarian algorithm is used to resolve a maximum matching problem of a qubit coupling graph. First, qubits are represented as vertexes in a graph, and a two-qubit gate operation between the qubits is represented as an edge, to construct a quantum coupling relationship graph G=(V,E). It is assumed that a quantity of vertexes is n. Then an n×n distance weight matrix is initialized, and values in the distance weight matrix are set to 0. Then, an unmatched node is found in a residual graph, a breadth first search is performed from the node to obtain a shortest path length from the node to each unmatched node, and a value in the weight matrix is updated based on the shortest path length. Then, an element having a smallest weight is found in the weight matrix to represent a shortest augmentation path, and a matching relationship is updated based on the element. After matching is performed, the residual graph needs to be updated. The process is repeated, each time a minimum weight augmentation path is found and the matching is expanded, until all nodes are matched, and a final matching result is the maximum matching.

After the maximum matching of the graph is obtained, a pair of qubits connected by each matching edge of the maximum matching is used as a vertex set, and the vertex set is added to the first vertex set family. Then other vertexes in the coupling graph that are directly connected to vertexes included in the first vertex set family and that do not belong to the first vertex set family are added to the second vertex set family.

The maximum matching of the coupling graph is constructed, and the first vertex set family is generated based on the maximum matching, so that each vertex set includes at least two vertexes in the coupling graph, and a connected subgraph corresponding to each vertex set may be generated, to provide a basis for subsequent qubit mapping of the logic circuit.

In some embodiments, the operation of generating the second vertex set family [symbol] ′ based on the first vertex set family [symbol] includes:
determining an initialized set Tₚ based on the first vertex set family, the initialized set Tₚ including vertexes that belong to the coupling graph and do not belong to the first vertex set family, p being a positive integer whose initial value is 1;
determining an initialized set Sₚ based on the initialized set Tₚ, the initialized set Sₚ including vertexes in the first vertex set family connected to the vertexes in the initialized set Tₚ;
determining that an initialized set Nᵢ⁰ is an empty set and determining that an initialized set A_{0,p} is an empty set, i being a positive integer whose initial value is 1;
placing an adjacent vertex of an i^{th} vertex in the set Tₚ\Uᵣ₌₀ⁱ⁻¹A_{r,p} in a set Sₚ into a set A_{i,p}, \ representing a difference set between two sets, and the adjacent vertex of the i^{th} vertex being a vertex connected to the i^{th} vertex;
determining a union set of a set Nᵢ^{p-1} and the set A_{i,p} as a set Nᵢ^{p};
if i is less than k₁, making i=i+1 and starting execution again from the operation of placing an adjacent vertex of an i^{th} vertex in the set Sₚ in a set Tₚ\∪ᵣ₌₀ⁱ⁻¹A_{r,p} into a set A_{i,p}, k₁ being a quantity of vertexes in the set Sₚ;
if i is equal to k₁, when |∪_{i∈[k}_{ₚ}_{]}Nᵢ^{p}| is greater than or equal to |Tₚ|/2, generating the second vertex set family, a vertex set included in the second vertex set family being a union set of the set Nᵢ^{p} and the i^{th} vertex in the set Sₚ, |∪_{i∈[k}_{ₚ}_{]}Nᵢ^{p}| representing a quantity of vertexes in ∪_{i∈[k}_{ₚ}_{]}Nᵢ^{p}, and |Tₚ| representing a quantity of vertexes in the set Tₚ;
determining a set Tₚ\∪_{r∈[k}_{₁}_{]}A_{r,p} as set Tₚ₊₁;
determining a set Sₚ₊₁ based on the set Tₚ and a set kₚ;
determining |Sₚ₊₁| as kₚ₊₁, |Sₚ₊₁| representing a quantity of vertexes in the set Sₚ₊₁;
if p is less than |T₁|, making p=p+1 and starting execution again from the operation of placing an adjacent vertex of an i^{th} vertex in the set Sₚ in a set Tₚ\∪ᵣ₌₀ⁱ⁻¹A_{r,p} into a set A_{i,p}; and
if p is equal to |T₁|, ending the procedure to obtain the finally generated second vertex set family.

In the foregoing descriptions of the operation, used symbol notations are merely used for describing ideas and processes of the algorithm. A specific symbol notation method is not limited in the embodiments of this application.

In some embodiments, to ensure that the quantity of vertexes included in each vertex set in the generated second vertex set family is greater than or equal to 2 and does not exceed the routing number of the coupling graph, when the adjacent vertex of the i^{th} vertex in the set Tₚ\∪ᵣ₌₀ⁱ⁻¹A_{r,p} in the set Sₚ is placed into the set A_{i,p}, if the i^{th} vertex in the set Sₚ has at most ┌|Tₚ|/kₚ┐ adjacent vertexes in the set Tₚ\∪ᵣ₌₀ⁱ⁻¹A_{r,p}, all adjacent vertexes of the i^{th} vertex in the set Tₚ\∪ᵣ₌₀ⁱ⁻¹A_{r,p} are selected and placed into the set A_{i,p}. If the i^{th} vertex in the set Sₚ has more than ┌|Tₚ|/kₚ┐ adjacent vertexes in the set Tₚ\∪ᵣ₌₀ⁱ⁻¹A_{r,p}, at most ┌|Tₚ|/kₚ┐ adjacent vertexes of the i^{th} vertex in the set Tₚ\∪ᵣ₌₀ⁱ⁻¹A_{r,p} are selected and placed into the set A_{i,p}, where ┌|Tₚ|/kₚ┐ represents rounding up |Tₚ|/kₚ.

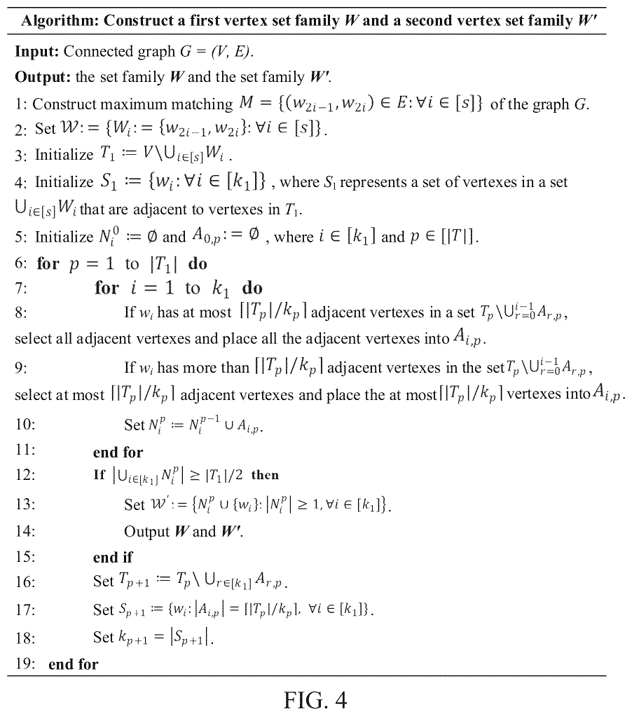

In a possible implementation, in this application, a graph algorithm is designed based on the foregoing operations, and the following describes conditions that the generated first vertex set family [symbol] and second vertex set family [symbol] ′ need to meet. FIG. 4 is a schematic diagram of pseudocode of a graph algorithm according to an embodiment of this application.

For any input graph G=(V,E), there are integers s and t. Two vertex set families [symbol] :={Wᵢ:Wᵢ⊆V and ∀i∈[s]} and [symbol] ′:={W′ⱼ:W′ⱼ⊆V and ∀j∈[t]} are outputted by using the algorithm, and the two vertexes set families meet the following conditions.

Condition 1: For any i∈[s] and j∈[t], subgraphs generated by Wᵢ and W′ⱼ are connected graphs.

Condition 2: For any i₁≠i₂∈[s] and j₁≠j₂∈[t], Wᵢ_{₁}∩Wᵢ_{₂}=∅ and W′ⱼ_{₁}∩W′ⱼ_{₂}=∅.

Condition 3: For any i∈[s] and j∈[t], 2≤|Wᵢ|=O(rt(G)) and 2≤|W′ⱼ|=O(rt(G)). To ensure that a quantity of vertexes of the connected subgraph is greater than or equal to 2 and does not exceed O(rt(G)).

Condition 4: |∪_{i∈[s]}Wᵢ|+|∪_{j∈[t]}W′ⱼ|=Ω(|V|), to ensure that all vertexes of the subgraph may cover a constant multiple of the vertex sets of the coupling graph.

The condition 1 to the condition 4 correspond to the conditions met by the first vertex set family and the second vertex set family respectively.

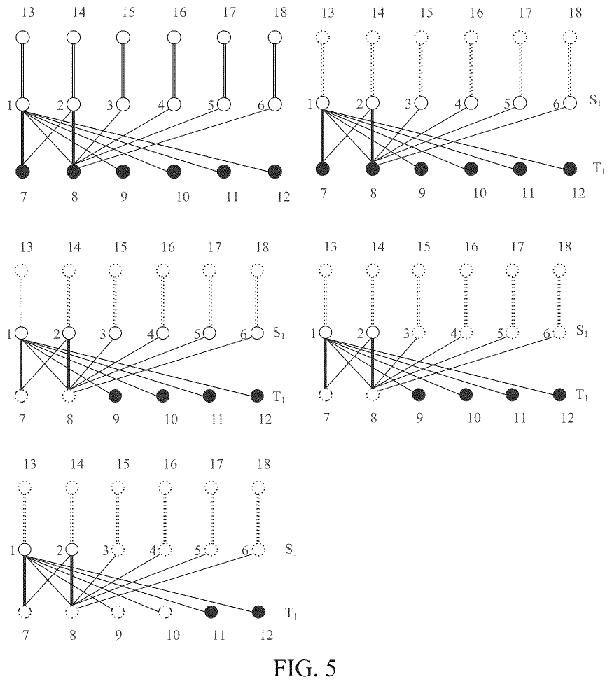

FIG. 5 is a schematic diagram of an instance of a graph algorithm according to an embodiment of this application. For example, the following describes in detail a running process of the pseudocode of the graph algorithm shown in FIG. 4 with reference to the instance.

Operation 1: Select maximum matching (a double solid line) in a graph, and a white vertex set corresponding to the maximum matching may be used to construct a set family [symbol] :={{1, 13}, {2, 14}, {3, 15}, {4, 16}, {5, 17}, {6, 18}}.

Operation 2: Select black vertexes (vertexes other than white vertexes in operation 1) as a set T₁ {7,8,9,10,11,12}, and select the vertexes (white vertexes) adjacent to vertexes in T₁ as S₁ {1,2,3,4,5,6}.

Operation 3: Because ┌|T₁|/k₁┐=1 (where k₁=|S₁|), for a vertex 1, select one neighbor {7} in T₁; and for a vertex 2, select a neighbor {8 in T₁†{7}:={8,9,10,11,12}. Because vertexes 3, 4, 5, and 6 have no neighbors in T₁†{7,8}{9,10,11,12}, the vertexes 3, 4, 5, and 6 are not selected. For a vertex in S₁, a corresponding set is defined as:
N₁¹={7}, N₂¹={8}, N₃¹=∅, N₄¹=∅, N₅¹=∅, N₆¹=∅

Because |∪_{i∈[6]}Nᵢ¹=2<|T₁|/2=3, a next operation is entered.

Operation 4: Because |N₁¹|=|N₂¹|=┌|T₁|/k₁┐=1 (where k₁=|S₁|), select S₂={1,2} and T₂:=T₁{7,8}={9,10,11,12}.

Operation 5: Because ┌|T₂|/k₂┐=2 (where k₂=|S₂|), for the vertex 1, select one neighbor {9,10} in T₂. Because vertexes 2, 3, 4, 5, and 6 have no neighbors in T₂\{9,10}:={11,12}, the vertexes 2, 3, 4, 5, and 6 are not selected. For a vertex in S₁, a corresponding set is defined as:
N₁²=N₁¹∪{9,10}={7,9,10}, N₂²={8}, N₃²=∅, N₄²=∅, N₅²=∅, N₆²=∅

Because |∪_{i∈[6]}Nᵢ²|=4>|T₁|/2=3, the algorithm outputs:
[symbol] :={{1, 13}, {2, 14}, {3, 15}, {4, 16}, {5, 17}, {6, 18}}
[symbol] ′:={N₁²∪{1}, N₂²∪{2}}={{1, 7, 9, 10}, {2, 8}}

A finally obtained connected subgraph includes a connected subgraph formed by vertex sets included in [symbol] and [symbol] ′.

In some embodiments, this application proves correctness of the graph algorithm shown in FIG. 4 as follows:

Condition 1: A set Wᵢ={w₂ᵢ₋₁, w₂ᵢ} in the set family [symbol] meets (w₂ᵢ₋₁, w₂ᵢ)∈M, where M is the maximum matching of the graph, each vertex of Nⱼ^{p} in a set W′ⱼ=Nⱼ^{p}∪{wⱼ} in the set family [symbol] ′ is adjacent to wⱼ. Therefore, a subgraph generated by Wᵢ and W′ⱼ is a connected graph.

Condition 2: It can be learned from construction of the set family [symbol] and the set family [symbol] ′ that, for any i₁≠i₂∈[s] and j₁≠j₂∈[t], and Wᵢ_{₁}∩Wᵢ_{₂}=∅ and W′ⱼ_{₁}∩W′ⱼ_{₂}=∅.

Condition 3: (1) The set family [symbol] : A routing number of the graph algorithm in row 2 and the complete graph described above is 2, and each element Wᵢ in the set family [symbol] meets 2=|Wᵢ|=rt(Kₙ)≤rt(G). (2) The set family [symbol] ′: In row 13 of the graph algorithm shown in FIG. 4, each element W′ⱼ in the set [symbol] ′ meets |Wⱼ′≥2. It is assumed that the algorithm stops at operation [symbol] of an outer loop. A set S [symbol] is rewrote as S [symbol] :={wⱼ_{ᵢ}:∀i∈[k₁] and ∀i∈[k [symbol] ]}. For any wⱼ_{ᵢ}∈S [symbol] , due to a definition of row 17 of the diagram algorithm shown in FIG. 4, and Nⱼ_{ᵢ} [symbol] ⁻¹=∪_{r∈[} [symbol] _{-1]}Aⱼ_{ᵢ}_{,r} and |Aⱼ_{ᵢ}_{,r}|=┌|Tᵣ|\kᵣ┐. Therefore, it can be learned that:

$$\vert {N}_{{j}_{i}}^{ℓ - 1} \vert = \vert {⋃}_{r ∈ [ ℓ - 1 ]} {A}_{{j}_{i} , r} \vert = {\sum }_{r ∈ [ ℓ - 1 ]} \vert {A}_{{j}_{i} , r} \vert = {\sum }_{r ∈ [ ℓ - 1 ]} ⌈ \vert {T}_{r} \vert / {k}_{r} ⌉$$

It is defined that a union set of sets corresponding to vertexes in [symbol] as C:= [symbol] . It can be obtained from the foregoing equation that:

$$\vert C \vert = {\sum }_{i ∈ [ {k}_{ℓ} ]} \vert {N}_{{j}_{i}}^{ℓ - 1} \vert = {k}_{ℓ} \cdot {\sum }_{r ∈ [ ℓ - 1 ]} ⌈ \vert {T}_{r} \vert / {k}_{r} ⌉$$

Because the graph algorithm has not stopped at operation [symbol] −1,

$$\vert C \vert = \vert {⋃}_{i ∈ [ {k}_{ℓ} ]} {N}_{{j}_{i}}^{ℓ - 1} \vert \leq \vert {⋃}_{i ∈ [ {k}_{1} ]} {N}_{{i}_{}}^{ℓ - 1} \vert < \vert {T}_{1} \vert / 2 \\ \vert {T}_{ℓ} \vert = \vert {T}_{ℓ - 1} \backslash {⋃}_{r = 0}^{{k}_{1}} {A}_{r , ℓ - 1} \vert = … = \vert {T}_{1} \backslash {⋃}_{p = 0}^{ℓ - 1} {⋃}_{r = 0}^{{k}_{1}} {A}_{r , p} \vert = \vert {T}_{1} \backslash {⋃}_{r = 1}^{{k}_{1}} {N}_{r}^{ℓ - 1} \vert \geq \vert {T}_{1} \vert - \vert {T}_{1} \vert / 2 = \vert {T}_{1} \vert / 2$$

Therefore, it can be obtained that |T [symbol] |≥|T₁|/2>|C|. It can be learned from construction of [symbol] and [symbol] that [symbol] ∩ [symbol] =∅, and for all u∈ [symbol] meet that all neighbors of u are included in [symbol] , that is, N(u)⊆ [symbol] . It can be learned from the foregoing description that, rt(G)=Ω(| [symbol] |/ [symbol] ). In conclusion, rt(G) meets:

$$r t ( G ) = Ω ( \vert {T}_{ℓ} \vert / {k}_{ℓ} ) = Ω ( 2 \vert {T}_{ℓ} \vert / {k}_{ℓ} ) > Ω ( ⌈ \vert {T}_{ℓ} \vert / {k}_{ℓ} ⌉ + \vert C \vert / {k}_{ℓ} ) = Ω ( {\sum }_{r ∈ [ ℓ ]} ⌈ \vert {T}_{r} \vert / {k}_{r} ⌉ )$$

Therefore, for any set [symbol] ∪{wᵢ} in [symbol] ′, a size of the set meets:

$$\vert {N}_{i}^{ℓ} ⋃ \{ {W}_{i} \} \vert = \vert {N}_{i}^{ℓ} \vert + 1 = {\sum }_{r ∈ [ ℓ ]} ⌈ \vert {T}_{r} \vert / {k}_{r} ⌉ + 1 = O ( rt ( G ) )$$

Therefore, the size of any set in [symbol] ′ is O(rt(G)).

Condition 4: It is assumed that the algorithm ends at operation [symbol] of the outer loop. It can be learned from row 3 and row 12 of the graph algorithm shown in FIG. 4 that elements of the set family [symbol] meet |∪_{i∈[s]}Wᵢ|=|V|−|T₁| and elements of the set family [symbol] ′ meet |∪_{j∈[t]}W′ⱼ|>|∪_{i∈[k}_{₁}_{]} [symbol] |≥|T₁|/2. Therefore, it can be obtained that |∪_{i∈[s]}Wᵢ|+|∪_{j∈[t]}W′ⱼ|=Ω(|V|).

In the foregoing method, a graph algorithm is designed to output a vertex set meeting a specific condition for any coupling graph, to construct a connected subgraph. The verification of the algorithm proves that the algorithm can operate as expected. This ensures that the designed qubit mapping method can be actually implemented and the corresponding graph algorithm can correctly and efficiently generate a required connected subgraph. In addition, the graph algorithm is verified to ensure implementability of the theory in this application and feasibility of the algorithm.

In the technical solutions provided in the embodiments of this application, the first vertex set family including a qubit pair corresponding to the maximum matching is constructed by using the maximum matching of the coupling graph. Then, a neighbor of the first vertex set family is found based on the first vertex set family to form the second vertex set family. In addition, the two set families are generated in consideration of conditions such as a size range limitation of a set and a connectivity requirement. The solution provides a simple and efficient preprocessing method for implementation of a hardware compilable circuit equivalent to any logic circuit by constructing a vertex set conducive to mapping.

The following describes the process of performing the qubit mapping on the logic circuit based on the at least two connected subgraphs to obtain the hardware compilable circuit equivalent to the logic circuit.

In some embodiments, a first quantity of logic bit pairs in the logic circuit are permuted based on the at least two connected subgraphs, the first quantity being a quantity of edges included in the maximum matching of the coupling graph, and each logic bit pair corresponding to two qubits on which one two-qubit gate in the logic circuit. A first portion of the hardware compilable circuit corresponding to the first quantity of logic bit pairs is generated; remaining logic bit pairs in the logic circuit are permuted based on the at least two connected subgraphs; a second portion of the hardware compilable circuit corresponding to the remaining logic bit pairs is generated; and the hardware compilable circuit equivalent to the logic circuit is obtained based on the first portion of the hardware compilable circuit and the second portion of the hardware compilable circuit.

The permutation here refers to a permutation of a graph: for a graph G=(V,E), a structure of the graph is reconstructed by changing a position of a node in V. Common algorithms for implementing the graph permutation include a matching-based permutation algorithm such as a swap algorithm and a permutation tree algorithm, a sorting-based permutation algorithm such as a bubble sorting, an insertion sorting, and a merging sorting, and a search-based permutation algorithm such as a depth first search (DFS), a breadth first search (BFS), and the like.

In a possible implementation, the permutation of the qubit coupling graph is implemented by using the swap algorithm, and an implementation process is as follows: A structure inside each connected subgraph is analyzed, and qubits that need to be permuted in the connected subgraph are determined. Within each subgraph, a local permutation of the qubits is completed by using the swap algorithm. In other words, an augmentation path is found in matching of the subgraph, and a swap operation is performed. The swap operation is repeated until the permutation inside each subgraph is completed. A connection relationship between the connected subgraphs is adjusted based on a requirement of a global permutation, and local permutations of the connected subgraphs are combined into the global permutation. A global permutation result is checked, and necessary corrections or adjustments are made. The foregoing operations are repeated to gradually improve precision of the permutation until the requirement of the logic circuit is met. Finally, the global permutation of the entire coupling graph is implemented. Finally, the permutation effect is verified, and a new graph structure after the permutation is saved.

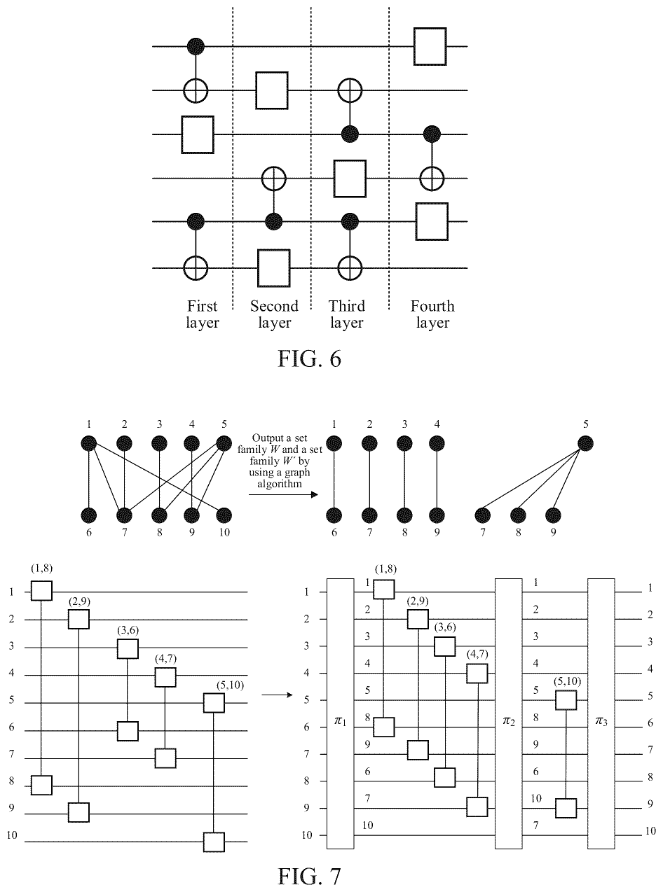

A quantity of basic quantum gate layers in the quantum circuit corresponds to parallel running time of the quantum algorithm. The quantity of basic quantum gate layers in the quantum circuit refers to a quantity of layers into which the quantum circuit is decomposed that only includes basic quantum gates (the basic quantum gates are basic operation units of the quantum computing, for example, CNOT gates and Hadamard gates). Each layer includes only basic gates that can be paralleled, and there is no dependency within the same layer, but there is dependency across layers. This determines a parallel execution capability of the quantum circuit and the time complexity of the quantum algorithm. In other words, if a quantum circuit includes L layers of basic quantum gates, the time complexity of the quantum algorithm that can be run in parallel on a quantum computer is O (L). For example, FIG. 6 is a schematic diagram of a quantity of quantum circuit layers according to an embodiment of this application. The figure represents a four-layer quantum circuit diagram. Therefore, the time complexity of the quantum algorithm running on the quantum computer is 0 (4).

The maximum matching quantity reflects an upper limit of a quantity of quantum gates that can be implemented in parallel in the quantum circuit, that is, if a maximum matching size of a graph. G is m, that is, in the quantum circuit, at most m two-qubit gates can be implemented by one layer. In a possible implementation, m two-qubit gates may be implemented through a permutation π1. It is assumed that a logic quantum circuit is wanted to be implemented, a depth is 1, and one layer includes └|V|/2┘ double qubits. Because m two-qubit gates have been implemented through the permutation π₁, and remaining └|V|/2┘—m two-qubit gates are permuted based on the connected subgraphs obtained above.

For example, FIG. 7 is a schematic diagram of construction of a hardware compilable circuit according to an embodiment of this application. First, two set families of a connected graph G are constructed by using the graph algorithm, namely [symbol] ={{1,6}, {2,7}, {3,8}, {4,9}} and [symbol] ′={{5,7,8,9}}. A construction process is based on the foregoing process of the graph algorithm, and details are not described herein. A hardware compilable circuit of an input circuit shown in the figure is constructed, and two-qubit gates in the circuit are denoted as (1,8), (2,9), (3,6), (4,7), (5,10), where a two-qubit gate (i, j) indicates that the two-qubit gate (i, j) acts on a qubit i and a qubit j. For example, (1, 8) indicates that the two-qubit gate acts on a qubit 1 and a qubit 8. A construction process is as follows: First, a qubit 6,7,8,9 is permuted to 8,9,6,7 by using a permutation algorithm (π₁). In this way, qubit pairs (1,8), (2,9), (3,6), (4,7) are adjacent on the figure, so that two-qubit gates corresponding to the qubit pairs may be directly acted on. A depth of the operation is O(rt(G))+1=O(rt(G)), whose depth is O(rt(G)), as described below. Secondly, a qubit 7,10 is permuted to 10,7 by using a permutation algorithm (π₂). In this way, a qubit pair (5,10) is adjacent on the figure, so that a two-qubit gate corresponding to the qubit pair may be directly acted on, and a depth of the operation is O(rt(G))+1=O(rt(G)).

Therefore, only a depth of O(rt(G)) is needed to complete the construction of the hardware compilable circuit of the logic circuit.

In some embodiments, for any input logic circuit, an additional circuit depth of the hardware compilable circuit outputted by an algorithm is at most O(rt(G)), where the additional circuit depth is a ratio of an output circuit depth to an input circuit depth.

A proof process is as follows: Based on |∪_{i∈[s]}Wᵢ|+|∪_{j∈[t]}W′ⱼ|=Ω(|V|), there is a constant c>0 meeting |∪_{i∈[s]}Wᵢ|≥c|V| or |∪_{j∈[t]}W′ⱼ|≥c|V|. Without loss of generality, it is assumed that |∪_{i∈[s]}Wᵢ|≥c|V|. For a specific integer k≤└|V|/2┘,

$$Gate := \{ ( {q}_{i} , {q}_{i + 1} ) : ∀ i ∈ [ k ] \}$$

represents a two-qubit gate set including a layer of circuits in any |V|-qubit logic circuit, and qᵢ, qᵢ₊₁ represent a logic bit in Gate. The corresponding hardware compilable quantum circuit is constructed as follows:
Σᵢ₌₁^{s}└|Wᵢ|/2┘ logic bit pairs in Gate are permuted to a vertex set ∪_{i∈[s]}Wᵢ and each set Wᵢ may be assigned to └|Wᵢ|/2┘ logic bit pairs. This process is equivalent to routing on the graph. G. Therefore, the circuit depth is rt(G). In a subgraph Gᵢ generated by each vertex set Wᵢ, because a distance between any two logic bits is at most 2, a two-qubit gate (a pair of logic bits) can be implemented by inserting at most one swap gate. Because |Wᵢ|=O(rt(G)), └|Wᵢ|/2┘=O(rt(G)) two-qubit gates exist in Wᵢ. Implementing all two-qubit gates in Gᵢ(Gᵢ) requires a quantum circuit whose depth is O(rt(G)). Because all vertexes of Gᵢ do not intersect, each two-qubit gate on Gᵢ may be implemented in parallel. The circuit depth of the operation is O(rt(G))+O(rt(G))=O(rt(G)).

Because

$$\vert {W}_{i} \vert \geq 2 , {\sum }_{i = 1}^{s} ⌊ \vert {W}_{i} \vert / 2 ⌋ \geq \frac{1}{3} {\sum }_{i = 1}^{s} \vert {W}_{i} \vert \geq c \vert V \vert / 3.$$

The foregoing operation is repeated for

$$⌈ \frac{k}{{\sum }_{i = 1}^{s} ⌊ \frac{\vert {W}_{i} \vert}{2} ⌋} ⌉ \leq ⌈ \vert V \vert / 2 ⌉ / ( c \vert V \vert / 3 ) = ⌈ 3 / ( 2 c ) ⌉$$

times, that is, all two-qubit gates in Gate may be implemented by a constant quantity of times.

Based on the foregoing method, for a layer of logic circuits, a logic circuit whose depth is 2·O(rt(G))=O(rt(G)) is obtained in this application. Therefore, for any coupling graph G, a worst additional depth of the coupling graph is [symbol] (G)=O(rt(G)).

In some embodiments, after the obtaining the hardware compilable circuit equivalent to the logic circuit based on the first portion of the hardware compilable circuit and the second portion of the hardware compilable circuit, the method further includes: permuting each logic bit in the logic circuit to an original position. The permutation to the original position is to facilitate an implementation of the quantum algorithm for a next time. For example, in FIG. 7, a permutation algorithm (π₃) is configured for restoring a qubit to an initial position of the qubit. A depth of the operation is O(rt(G)).

In the technical solutions provided in the embodiments of this application, the permutation of the qubit is completed based on the connected subgraph, and this permutation process has high concurrency. A permutation of logic quanta may be completed inside a subgraph, thereby reducing a quantity of inserted swap gates, and effectively controlling an additional depth of a total mapping circuit. Even if mapping is performed between subgraphs, mapping inside the subgraphs may be used to help reduce a distance between qubits. In this map segmentation-based mapping method, the distance between qubits can be globally optimized, and an additional circuit depth of mapping can be globally controlled. In other words, for any input logic circuit, an additional circuit depth of the hardware compilable circuit outputted by an algorithm is at most O(rt(G)), where the additional circuit depth is a ratio of an output circuit depth to an input circuit depth.

Apparatus embodiments of this application are described below, and may be used to perform the method embodiments of this application. For details not disclosed in the apparatus embodiments of this application, refer to the method embodiments of this application.

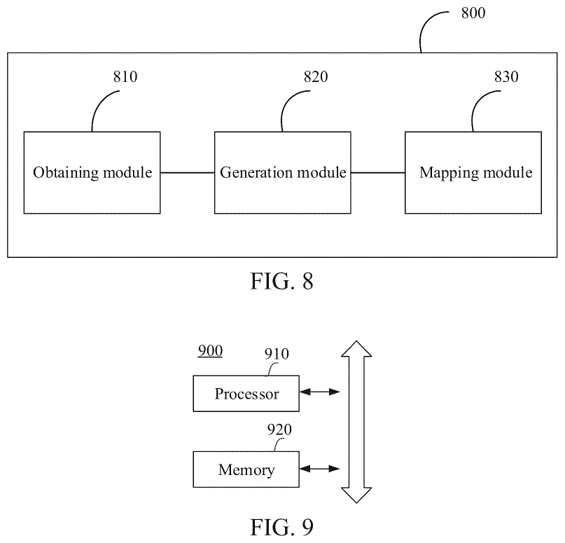

FIG. 8 is a block diagram of a qubit mapping apparatus according to an embodiment of this application. The apparatus has a function of performing the foregoing qubit mapping method, the function may be implemented by hardware or may be implemented by hardware executing corresponding software. The apparatus may be a computer device, or may be arranged in a computer device. The apparatus 800 includes an obtaining module 810, a generation module 820, and a mapping module 830.

The obtaining module 810 is configured to obtain a coupling graph corresponding to a quantum device, each vertex in the coupling graph representing one qubit in the quantum device, an edge between two vertexes representing that a two-qubit gate is allowed to directly act on qubits corresponding to the two vertexes.

The generation module 820 is configured to generate at least two connected subgraphs based on the coupling graph, a quantity of vertexes of each connected subgraph being greater than or equal to 2 and less than or equal to a routing number of the coupling graph, a sum of quantities of vertexes of the at least two connected subgraphs being equal to a constant multiple of a quantity of vertexes of the coupling graph, and the routing number of the coupling graph being a maximum quantity of permutation rounds of all permutations on the coupling graph.

The mapping module 830 is configured to perform qubit mapping on a logic circuit based on the at least two connected subgraphs, to obtain a hardware compilable circuit equivalent to the logic circuit.

In some embodiments, the generation module 820 includes a first generation unit and a second generation unit (not shown in FIG. 8).

The first generation unit is configured to generate a first vertex set family and a second vertex set family based on the coupling graph, the first vertex set family including at least one vertex set, the second vertex set family including at least one vertex set, each vertex set including at least two vertexes in the coupling graph.

The second generation unit is configured to generate a connected subgraph corresponding to each vertex set in the first vertex set family and the second vertex set family, to obtain the at least two connected subgraphs.

The first vertex set family and the second vertex set family meet the following conditions:
a subgraph corresponding to each vertex set in the first vertex set family and the second vertex set family is a connected graph;
same vertexes do not exist in any two vertex sets in the first vertex set family, and same vertexes do not exist in any two vertex sets in the second vertex set family;
a quantity of vertexes in each vertex set in the first vertex set family and the second vertex set family is greater than or equal to 2 and less than or equal to the routing number of the coupling graph; and
a total quantity of vertexes in the first vertex set family and the second vertex set family is equal to a constant multiple of the quantity of vertexes of the coupling graph.

In some embodiments, the first generation unit includes a construction subunit, a first generation subunit, and a second generation subunit (not shown in FIG. 8).

The construction subunit is configured to construct maximum matching of the coupling graph, the maximum matching including at least one edge in the coupling graph.

The first generation subunit is configured to generate the first vertex set family based on the maximum matching, each vertex set in the first vertex set family corresponding to two vertexes connected by an edge included in the maximum matching.

The second generation subunit is configured to generate the second vertex set family based on the first vertex set family.

In some embodiments, the second generation subunit is configured to:
determine an initialized set Tₚ based on the first vertex set family, the initialized set Tₚ including vertexes that belong to the coupling graph and do not belong to the first vertex set family, p being a positive integer whose initial value is 1;
determine an initialized set Sₚ based on the initialized set Tₚ, the initialized set Sₚ including vertexes in the first vertex set family connected to the vertexes in the initialized set Tₚ;
determine that an initialized set Nᵢ⁰ is an empty set and determine that an initialized set A_{0,p} is an empty set, i being a positive integer whose initial value is 1;
place an adjacent vertex of an i^{th} vertex in the set Tₚ\∪ᵣ₌₀ⁱ⁻¹A_{r,p} in a set Sₚ into a set A_{i,p}, \ representing a difference set between two sets, and the adjacent vertex of the i^{th} vertex being a vertex connected to the i^{th} vertex;
determine a union set of a set Nᵢ^{p-1} and the set A_{i,p} as a set Nᵢ^{p};
if i is less than k₁, make i=i+1 and starte execution again from the operation of placing an adjacent vertex of an i^{th} vertex in the set Sₚ in a set Tₚ\∪ᵣ₌₀ⁱ⁻¹A_{r,p} into a set A_{i,p}, k₁ being a quantity of vertexes in the set Sₚ;
if i is equal to k₁, when |∪_{i∈[k}_{ₚ}_{]}Nᵢ^{p}| is greater than or equal to |Tₚ|/2, generate the second vertex set family, a vertex set included in the second vertex set family being a union set of the set Nᵢ^{p} and the i^{th} vertex in the set Sₚ, |∪_{i∈[k}_{ₚ}_{]}Nᵢ^{p}| representing a quantity of vertexes in ∪_{i∈[k}_{ₚ}_{]}Nᵢ^{p}, and |Tₚ| representing a quantity of vertexes in the set Tₚ;
determine a set Tₚ\∪_{r∈[k}_{₁}_{]}A_{r,p} as a set Tₚ₊₁;
determine a set Sₚ₊₁ based on the set Tₚ and a set kₚ;
determine |Sₚ₊₁| as kₚ₊₁, |Sₚ₊₁| representing a quantity of vertexes in the set Sₚ₊₁;
if p is less than |T₁|, make p=p+1 and start execution again from the operation of placing an adjacent vertex of an i^{th} vertex in the set Sₚ in a set Tₚ\∪ᵣ₌₀ⁱ⁻¹A_{r,p} into a set A_{i,p}; and
if p is equal to |T₁|, end the procedure to obtain the finally generated second vertex set family.

In some embodiments, the second generation subunit is configured to:
if the i^{th} vertex in the set Sₚ has at most ┌|Tₚ|/kₚ┐ adjacent vertexes in the set Tₚ\∪ᵣ₌₀ⁱ⁻¹A_{r,p}, select all adjacent vertexes of the i^{th} vertex in the set Tₚ\∪ᵣ₌₀ⁱ⁻¹A_{r,p} and place all the adjacent vertexes into the set A_{i,p}; and
if the i^{th} vertex in the set Sₚ has more than ┌|Tₚ|/kₚ┐ adjacent vertexes in the set Tₚ\∪ᵣ₌₀ⁱ⁻¹A_{r,p}, select at most ┌|Tₚ|/kₚ┐ adjacent vertexes of the i^{th} vertex in the set Tₚ\μᵣ₌₀ⁱ⁻¹A_{r,p} and place the at most ┌|Tₚ|/kₚ┐ adjacent vertexes into the set A_{i,p},
┌|Tₚ|/kₚ┐ represents rounding up |Tₚ|/kₚ.

In some embodiments, the mapping module 830 includes a first permutation unit, a third generation unit, a second permutation unit, a fourth generation unit, and an obtaining unit (not shown in FIG. 8).

The first permutation unit is configured to permute a first quantity of logic bit pairs in the logic circuit based on the at least two connected subgraphs, the first quantity being a quantity of edges included in the maximum matching of the coupling graph, and each logic bit pair corresponding to two qubits on which one two-qubit gate acts in the logic circuit.

The third generation unit is configured to generate a first portion of the hardware compilable circuit corresponding to the first quantity of logic bit pairs.

The second permutation unit is configured to permute remaining logic bit pairs in the logic circuit based on the at least two connected subgraphs.

The fourth generation unit is configured to generate a second portion of the hardware compilable circuit corresponding to the remaining logic bit pairs.

The obtaining unit is configured to obtain the hardware compilable circuit equivalent to the logic circuit based on the first portion of the hardware compilable circuit and the second portion of the hardware compilable circuit.

In some embodiments, the mapping module 830 further includes a third permutation unit (not shown in FIG. 8).

The third permutation unit is configured to permute each logic bit in the logic circuit to an original position.

When the apparatus provided in the foregoing embodiment implements the functions of the apparatus, only division of the foregoing function modules is used as an example for description. In a practical application, the functions may be allocated to and completed by different function modules based on requirements, that is, an internal structure of the device is divided into different function modules, to complete all or some of the functions described above. In addition, the apparatuses provided in the foregoing embodiments and the method embodiments belong to a same concept. For specific implementation processes of the apparatuses, refer to the method embodiments. Details are not described herein again.

FIG. 9 is a block diagram of a structure of a computer device 900 according to an embodiment of this application.

Generally, the computer device 900 includes a processor 910 and a memory 920.

The processor 910 may include one or more processing cores, for example, a 4-core processor or an 8-core processor. The processor 910 may be implemented in at least one hardware form of digital signal processing (DSP), a field programmable gate array (FPGA), and a programmable logic array (PLA). The processor 910 may further include a main processor and a coprocessor. The main processor is a processor configured to process data in an awake state, and is also referred to as a central processing unit (CPU). The coprocessor is a low power consumption processor configured to process the data in a standby state. In some embodiments, the processor 910 may be integrated with a graphics processing unit (GPU). The GPU is configured to render and draw content that needs to be displayed on a display screen. In some embodiments, the processor 910 may further include an Al processor. The Al processor is configured to process computing operations related to machine learning.

The memory 920 may include one or more computer-readable storage media. The computer-readable storage medium may be non-transient. The memory 920 may further include a high-speed random memory, and a nonvolatile memory, for example, one or more disk storage devices and flash memory storage devices. In some embodiments, the non-transitory computer-readable storage medium in the memory 920 is configured to store a computer program, and the computer program is configured to be executed by one or more processors to implement the foregoing qubit mapping method.

A person skilled in the art may understand that the structure shown in FIG. 9 constitutes no limitation on the computer device 900, and the computer device may include more or fewer components than those shown in the figure, or some components may be combined, or a different component deployment may be used.

In some embodiments, a non-transitory computer-readable storage medium is further provided, the storage medium having a computer program stored therein, the computer program, when executed and performed by a processor, implementing the foregoing qubit mapping method.

In some embodiments, the computer-readable storage medium may include: a read-only memory (ROM), a random access memory (RAM), a solid state drive (SSD), and an optical disc. The RAM may include a resistance random access memory (ReRAM) and a dynamic random access memory (DRAM).

In some embodiments, a computer program product is further provided, where the computer program product includes a computer program, the computer program is stored in a computer-readable storage medium, and a processor reads and executes the computer program from the computer-readable storage medium, to implement the foregoing qubit mapping method.

“A plurality of” in this specification means two or more. The term “and/or” describes an association relationship between associated objects and represents that three relationships may exist. For example, A and/or B may represent the following three cases: Only A exists, both A and B exist, and only B exists. The character “/” generally represents that the associated object is in an “or” relationship. In addition, the operation numbers described in this specification merely exemplarily show a possible execution sequence between the operations. In some other embodiments, the operations may not be performed based on a number sequence. For example, two operations having different numbers are performed simultaneously, or the two operations having different numbers are performed based on a sequence contrary to that shown in the figure. This is not limited in the embodiments of this application.

The foregoing descriptions are merely example embodiments of this application, but are not intended to limit this application. Any modification, equivalent replacement, or improvement made without departing from the spirit and principle of this application shall fall within the protection scope of this application.

What is claimed is:

1. A qubit mapping method performed by a computer device, the method comprising:
obtaining a coupling graph corresponding to a quantum device, each vertex in the coupling graph representing one qubit in the quantum device, an edge between two vertexes representing that a two-qubit gate is allowed to directly act on qubits corresponding to the two vertexes;
generating at least two connected subgraphs based on the coupling graph, a quantity of vertexes of each connected subgraph being greater than or equal to 2 and less than or equal to a routing number of the coupling graph, a sum of quantities of vertexes of the at least two connected subgraphs being equal to a constant multiple of a quantity of vertexes of the coupling graph, and the routing number of the coupling graph being a maximum quantity of permutation rounds of all permutations on the coupling graph; and
performing qubit mapping on a logic circuit based on the at least two connected subgraphs, to obtain a hardware compilable circuit equivalent to the logic circuit.

2. The method according to claim 1, wherein the generating at least two connected subgraphs based on the coupling graph comprises:
generating a first vertex set family and a second vertex set family based on the coupling graph, the first vertex set family comprising at least one vertex set, the second vertex set family comprising at least one vertex set, each vertex set comprising at least two vertexes in the coupling graph; and
generating a connected subgraph corresponding to each vertex set in the first vertex set family and the second vertex set family, to obtain the at least two connected subgraphs,
the first vertex set family and the second vertex set family meeting the following conditions:
a subgraph corresponding to each vertex set in the first vertex set family and the second vertex set family is a connected graph;
same vertexes do not exist in any two vertex sets in the first vertex set family, and same vertexes do not exist in any two vertex sets in the second vertex set family;
a quantity of vertexes in each vertex set in the first vertex set family and the second vertex set family is greater than or equal to 2 and less than or equal to the routing number of the coupling graph; and
a total quantity of vertexes in the first vertex set family and the second vertex set family is equal to a constant multiple of the quantity of vertexes of the coupling graph.

3. The method according to claim 2, wherein the generating a first vertex set family and a second vertex set family based on the coupling graph comprises:
constructing maximum matching of the coupling graph, the maximum matching comprising at least one edge in the coupling graph;
generating the first vertex set family based on the maximum matching, each vertex set in the first vertex set family corresponding to two vertexes connected by an edge comprised in the maximum matching; and
generating the second vertex set family based on the first vertex set family.

4. The method according to claim 3, wherein the generating the second vertex set family based on the first vertex set family comprises:
determining an initialized set Tₚ based on the first vertex set family, the initialized set Tₚ comprising vertexes that belong to the coupling graph and do not belong to the first vertex set family, p being a positive integer whose initial value is 1;
determining an initialized set Sₚ based on the initialized set Tₚ, the initialized set Sₚ comprising vertexes in the first vertex set family connected to the vertexes in the initialized set Tₚ;
determining that an initialized set Nᵢ⁰ is an empty set and determining that an initialized set A_{0,p} is an empty set, i being a positive integer whose initial value is 1;
placing an adjacent vertex of an i^{th} vertex in the set Sₚ in a set Tₚ\∪ᵣ₌₀ⁱ⁻¹A_{r,p} into a set A_{i,p}, \ representing a difference set between two sets, and the adjacent vertex of the i^{th} vertex being a vertex connected to the i^{th} vertex;
determining a union set of a set Nᵢ^{p-1} and the set A_{i,p} as a set Nᵢ^{p};
if i is less than k₁, making i=i+1 and starting execution again from the operation of placing an adjacent vertex of an i^{th} vertex in the set Sₚ in a set Tₚ\∪ᵣ₌₀ⁱ⁻¹A_{r,p} into a set A_{i,p}, k₁ being a quantity of vertexes in the set Sₚ;
if i is equal to k₁, when |∪_{i∈[k}_{ₚ}_{]}Nᵢ^{p}| is greater than or equal to |Tₚ|/2, generating the second vertex set family, a vertex set comprised in the second vertex set family being a union set of the set Nᵢ^{p} and the i^{th} vertex in the set Sₚ, |∪_{i∈[k}_{ₚ}_{]}Nᵢ^{p}| representing a quantity of vertexes in ∪_{i∈[k}_{ₚ}_{]}Nᵢ^{p}, and |Tₚ| representing a quantity of vertexes in the set Tₚ;
determining a set Tₚ\∪_{r∈[k}_{₁}_{]}A_{r,p} as set Tₚ₊₁;
determining a set Sₚ₊₁ based on the set Tₚ and a set kₚ;
determining |Sₚ₊₁| as kₚ₊₁, |Sₚ₊₁| representing a quantity of vertexes in the set Sₚ₊₁;
if p is less than |T₁|, making p=p+1 and starting execution again from the operation of placing an adjacent vertex of an i^{th} vertex in the set Sₚ in a set Tₚ\∪ᵣ₌₀ⁱ⁻¹A_{r,p} into a set A_{i,p}; and
if p is equal to |T₁|, ending the procedure to obtain the finally generated second vertex set family.

5. The method according to claim 4, wherein the placing an adjacent vertex of an i^{th} vertex in the set Sₚ in a set Tₚ\∪ᵣ₌₀ⁱ⁻¹A_{r,p} into a set A_{i,p} comprises:
if the i^{th} vertex in the set Sₚ has at most ┌|Tₚ|/kₚ┐ adjacent vertexes in the set Tₚ\∪ᵣ₌₀ⁱ⁻¹A_{r,p}, selecting all adjacent vertexes of the i^{th} vertex in the set Tₚ\∪ᵣ₌₀ⁱ⁻¹A_{r,p} and placing all the adjacent vertexes into the set A_{i,p}; or
if the i^{th} vertex in the set Sₚ has more than ┌|Tₚ|/kₚ┐ adjacent vertexes in the set Tₚ\∪ᵣ₌₀ⁱ⁻¹A_{r,p}, selecting at most ┌|Tₚ|/kₚ┐ adjacent vertexes of the i^{th} vertex in the set Tₚ\∪ᵣ₌₀ⁱ⁻¹A_{r,p} and placing the at most ┌|Tₚ|/kₚ┐ adjacent vertexes into the set A_{i,p},
┌|Tₚ|/kₚ┐ representing rounding up |Tₚ|/kₚ.

6. The method according to claim 1, wherein the performing qubit mapping on a logic circuit based on the at least two connected subgraphs, to obtain a hardware compilable circuit equivalent to the logic circuit comprises:
permuting a first quantity of logic bit pairs in the logic circuit based on the at least two connected subgraphs, the first quantity being a quantity of edges comprised in the maximum matching of the coupling graph, and each logic bit pair corresponding to two qubits on which one two-qubit gate acts in the logic circuit;
generating a first portion of the hardware compilable circuit corresponding to the first quantity of logic bit pairs;
permuting remaining logic bit pairs in the logic circuit based on the at least two connected subgraphs;
generating a second portion of the hardware compilable circuit corresponding to the remaining logic bit pairs; and
obtaining the hardware compilable circuit equivalent to the logic circuit based on the first portion of the hardware compilable circuit and the second portion of the hardware compilable circuit.

7. The method according to claim 6, wherein after the obtaining the hardware compilable circuit equivalent to the logic circuit based on the first portion of the hardware compilable circuit and the second portion of the hardware compilable circuit, the method further comprises:
permuting each logic bit in the logic circuit to an original position.

8. A computer device, comprising a processor and a memory, the memory having a computer program stored therein that, when loaded and executed by the processor, causes the computer device to implement a qubit mapping method including:
obtaining a coupling graph corresponding to a quantum device, each vertex in the coupling graph representing one qubit in the quantum device, an edge between two vertexes representing that a two-qubit gate is allowed to directly act on qubits corresponding to the two vertexes;
generating at least two connected subgraphs based on the coupling graph, a quantity of vertexes of each connected subgraph being greater than or equal to 2 and less than or equal to a routing number of the coupling graph, a sum of quantities of vertexes of the at least two connected subgraphs being equal to a constant multiple of a quantity of vertexes of the coupling graph, and the routing number of the coupling graph being a maximum quantity of permutation rounds of all permutations on the coupling graph; and
performing qubit mapping on a logic circuit based on the at least two connected subgraphs, to obtain a hardware compilable circuit equivalent to the logic circuit.

9. The computer device according to claim 8, wherein the generating at least two connected subgraphs based on the coupling graph comprises:
generating a first vertex set family and a second vertex set family based on the coupling graph, the first vertex set family comprising at least one vertex set, the second vertex set family comprising at least one vertex set, each vertex set comprising at least two vertexes in the coupling graph; and
generating a connected subgraph corresponding to each vertex set in the first vertex set family and the second vertex set family, to obtain the at least two connected subgraphs,
the first vertex set family and the second vertex set family meeting the following conditions:
a subgraph corresponding to each vertex set in the first vertex set family and the second vertex set family is a connected graph;
same vertexes do not exist in any two vertex sets in the first vertex set family, and same vertexes do not exist in any two vertex sets in the second vertex set family;
a quantity of vertexes in each vertex set in the first vertex set family and the second vertex set family is greater than or equal to 2 and less than or equal to the routing number of the coupling graph; and
a total quantity of vertexes in the first vertex set family and the second vertex set family is equal to a constant multiple of the quantity of vertexes of the coupling graph.

10. The computer device according to claim 9, wherein the generating a first vertex set family and a second vertex set family based on the coupling graph comprises:
constructing maximum matching of the coupling graph, the maximum matching comprising at least one edge in the coupling graph;
generating the first vertex set family based on the maximum matching, each vertex set in the first vertex set family corresponding to two vertexes connected by an edge comprised in the maximum matching; and
generating the second vertex set family based on the first vertex set family.

11. The computer device according to claim 10, wherein the generating the second vertex set family based on the first vertex set family comprises:
determining an initialized set Tₚ based on the first vertex set family, the initialized set Tₚ comprising vertexes that belong to the coupling graph and do not belong to the first vertex set family, p being a positive integer whose initial value is 1;
determining an initialized set Sₚ based on the initialized set Tₚ, the initialized set Sₚ comprising vertexes in the first vertex set family connected to the vertexes in the initialized set Tₚ;
determining that an initialized set Nᵢ⁰ is an empty set and determining that an initialized set A_{0,p} is an empty set, i being a positive integer whose initial value is 1;
placing an adjacent vertex of an i^{th} vertex in the set Sₚ in a set Tₚ\∪ᵣ₌₀ⁱ⁻¹A_{r,p} into a set A_{i,p}, \ representing a difference set between two sets, and the adjacent vertex of the i^{th} vertex being a vertex connected to the i^{th} vertex;
determining a union set of a set Nᵢ^{p-1} and the set A_{i,p} as a set Nᵢ^{p};
if i is less than k₁, making i=i+1 and starting execution again from the operation of placing an adjacent vertex of an i^{th} vertex in the set Sₚ in a set Tₚ\∪ᵣ₌₀ⁱ⁻¹A_{r,p} into a set A_{i,p}, k₁ being a quantity of vertexes in the set Sₚ;
if i is equal to k₁, when |∪_{i∈[k}_{ₚ}_{]}Nᵢ^{p}| is greater than or equal to |Tₚ|/2, generating the second vertex set family, a vertex set comprised in the second vertex set family being a union set of the set Nᵢ^{p} and the i^{th} vertex in the set Sₚ, |U_{i∈[k}_{ₚ}_{]}Nᵢ^{p}| representing a quantity of vertexes in ∪_{i∈[k}_{ₚ}_{]}Nᵢ^{p}, and |Tₚ| representing a quantity of vertexes in the set Tₚ;
determining a set Tₚ\∪_{r∈[k}_{₁}_{]}A_{r,p} as set Tₚ₊₁;
determining a set Sₚ₊₁ based on the set Tₚ and a set kₚ;
determining |Sₚ₊₁| as kₚ₊₁, |Sₚ₊₁| representing a quantity of vertexes in the set Sₚ₊₁;
if p is less than |T₁|, making p=p+1 and starting execution again from the operation of placing an adjacent vertex of an i^{th} vertex in the set Sₚ in a set Tₚ\∪ᵣ₌₀ⁱ⁻¹A_{r,p} into a set A_{i,p}; and
if p is equal to |T₁|, ending the procedure to obtain the finally generated second vertex set family.

12. The computer device according to claim 11, wherein the placing an adjacent vertex of an i^{th} vertex in the set Sₚ in a set Tₚ\∪ᵣ₌₀ⁱ⁻¹A_{r,p} into a set A_{i,p} comprises:
if the i^{th} vertex in the set Sₚ has at most ┌|Tₚ|/kₚ┐ adjacent vertexes in the set Tₚ\∪ᵣ₌₀ⁱ⁻¹A_{r,p}, selecting all adjacent vertexes of the i^{th} vertex in the set Tₚ\∪ᵣ₌₀ⁱ⁻¹A_{r,p} and placing all the adjacent vertexes into the set A_{i,p}; or
if the i^{th} vertex in the set Sₚ has more than ┌|Tₚ|/kₚ┐ adjacent vertexes in the set Tₚ\∪ᵣ₌₀ⁱ⁻¹A_{r,p}, selecting at most ┌|Tₚ|/kₚ┐ adjacent vertexes of the i^{th} vertex in the set Tₚ\∪ᵣ₌₀ⁱ⁻¹A_{r,p} and placing the at most ┌|Tₚ|/kₚ┐ adjacent vertexes into the set A_{i,p},
┌|Tₚ|/kₚ┐ representing rounding up |Tₚ|/kₚ.

13. The computer device according to claim 8, wherein the performing qubit mapping on a logic circuit based on the at least two connected subgraphs, to obtain a hardware compilable circuit equivalent to the logic circuit comprises:
permuting a first quantity of logic bit pairs in the logic circuit based on the at least two connected subgraphs, the first quantity being a quantity of edges comprised in the maximum matching of the coupling graph, and each logic bit pair corresponding to two qubits on which one two-qubit gate acts in the logic circuit;
generating a first portion of the hardware compilable circuit corresponding to the first quantity of logic bit pairs;
permuting remaining logic bit pairs in the logic circuit based on the at least two connected subgraphs;
generating a second portion of the hardware compilable circuit corresponding to the remaining logic bit pairs; and
obtaining the hardware compilable circuit equivalent to the logic circuit based on the first portion of the hardware compilable circuit and the second portion of the hardware compilable circuit.

14. The computer device according to claim 13, wherein after the obtaining the hardware compilable circuit equivalent to the logic circuit based on the first portion of the hardware compilable circuit and the second portion of the hardware compilable circuit, the method further comprises:
permuting each logic bit in the logic circuit to an original position.

15. A non-transitory computer-readable storage medium having a computer program stored therein that, when loaded and executed by a processor of a computer device, causes the computer device to implement a qubit mapping method including:
obtaining a coupling graph corresponding to a quantum device, each vertex in the coupling graph representing one qubit in the quantum device, an edge between two vertexes representing that a two-qubit gate is allowed to directly act on qubits corresponding to the two vertexes;
generating at least two connected subgraphs based on the coupling graph, a quantity of vertexes of each connected subgraph being greater than or equal to 2 and less than or equal to a routing number of the coupling graph, a sum of quantities of vertexes of the at least two connected subgraphs being equal to a constant multiple of a quantity of vertexes of the coupling graph, and the routing number of the coupling graph being a maximum quantity of permutation rounds of all permutations on the coupling graph; and
performing qubit mapping on a logic circuit based on the at least two connected subgraphs, to obtain a hardware compilable circuit equivalent to the logic circuit.

16. The non-transitory computer-readable storage medium according to claim 15, wherein the generating at least two connected subgraphs based on the coupling graph comprises:
generating a first vertex set family and a second vertex set family based on the coupling graph, the first vertex set family comprising at least one vertex set, the second vertex set family comprising at least one vertex set, each vertex set comprising at least two vertexes in the coupling graph; and
generating a connected subgraph corresponding to each vertex set in the first vertex set family and the second vertex set family, to obtain the at least two connected subgraphs,
the first vertex set family and the second vertex set family meeting the following conditions:
a subgraph corresponding to each vertex set in the first vertex set family and the second vertex set family is a connected graph;
same vertexes do not exist in any two vertex sets in the first vertex set family, and same vertexes do not exist in any two vertex sets in the second vertex set family;
a quantity of vertexes in each vertex set in the first vertex set family and the second vertex set family is greater than or equal to 2 and less than or equal to the routing number of the coupling graph; and
a total quantity of vertexes in the first vertex set family and the second vertex set family is equal to a constant multiple of the quantity of vertexes of the coupling graph.

17. The non-transitory computer-readable storage medium according to claim 16, wherein the generating a first vertex set family and a second vertex set family based on the coupling graph comprises:
constructing maximum matching of the coupling graph, the maximum matching comprising at least one edge in the coupling graph;
generating the first vertex set family based on the maximum matching, each vertex set in the first vertex set family corresponding to two vertexes connected by an edge comprised in the maximum matching; and
generating the second vertex set family based on the first vertex set family.

18. The non-transitory computer-readable storage medium according to claim 17, wherein the generating the second vertex set family based on the first vertex set family comprises:
determining an initialized set Tₚ based on the first vertex set family, the initialized set Tₚ comprising vertexes that belong to the coupling graph and do not belong to the first vertex set family, p being a positive integer whose initial value is 1;
determining an initialized set Sₚ based on the initialized set Tₚ, the initialized set Sₚ comprising vertexes in the first vertex set family connected to the vertexes in the initialized set Tₚ;
determining that an initialized set Nᵢ⁰ is an empty set and determining that an initialized set A_{0,p} is an empty set, i being a positive integer whose initial value is 1;
placing an adjacent vertex of an i^{th} vertex in the set Sₚ in a set Tₚ\∪ᵣ₌₀ⁱ⁻¹A_{r,p} into a set A_{i,p}, \ representing a difference set between two sets, and the adjacent vertex of the i^{th} vertex being a vertex connected to the i^{th} vertex;
determining a union set of a set Nᵢ^{p-1} and the set A_{i,p} as a set Nᵢ^{p};
if i is less than k₁, making i=i+1 and starting execution again from the operation of placing an adjacent vertex of an i^{th} vertex in the set Sₚ in a set Tₚ\∪ᵣ₌₀ⁱ⁻¹A_{r,p} into a set A_{i,p}, k₁ being a quantity of vertexes in the set Sₚ;
if i is equal to k₁, when |∪_{i∈[k}_{ₚ}_{]}Nᵢ^{p}| is greater than or equal to |Tₚ|/2, generating the second vertex set family, a vertex set comprised in the second vertex set family being a union set of the set Nᵢ^{p} and the i^{th} vertex in the set Sₚ, |∪_{i∈[k}_{ₚ}_{]}Nᵢ^{p}| representing a quantity of vertexes in ∪_{i∈[k}_{ₚ}_{]}Nᵢ^{p}, and |Tₚ| representing a quantity of vertexes in the set Tₚ;
determining a set Tₚ\∪_{i∈[k}_{ₚ}_{]}A_{r,p} as a set Tₚ₊₁;
determining a set Sₚ₊₁ based on the set Tₚ and a set kₚ;
determining |Sₚ₊₁| as kₚ₊₁, |Sₚ₊₁| representing a quantity of vertexes in the set Sₚ₊₁;
if p is less than |T₁|, making p=p+1 and starting execution again from the operation of placing an adjacent vertex of an i^{th} vertex in the set Sₚ in a set Tₚ\∪ᵣ₌₀ⁱ⁻¹A_{r,p} into a set A_{i,p}; and
if p is equal to |T₁|, ending the procedure to obtain the finally generated second vertex set family.

19. The non-transitory computer-readable storage medium according to claim 18, wherein the placing an adjacent vertex of an i^{th} vertex in the set Sₚ in a set Tₚ\∪ᵣ₌₀ⁱ⁻¹A_{r,p} into a set A_{i,p} comprises:
if the i^{th} vertex in the set Sₚ has at most ┌|Tₚ|/kₚ┐ adjacent vertexes in the set Tₚ\∪ᵣ₌₀ⁱ⁻¹A_{r,p}, selecting all adjacent vertexes of the i^{th} vertex in the set Tₚ\∪ᵣ₌₀ⁱ⁻¹A_{r,p} and placing all the adjacent vertexes into the set A_{i,p}; or
if the i^{th} vertex in the set Sₚ has more than ┌|Tₚ|/kₚ┐ adjacent vertexes in the set Tₚ\∪ᵣ₌₀ⁱ⁻¹A_{r,p}, selecting at most ┌|Tₚ|/kₚ┐ adjacent vertexes of the i^{th} vertex in the set Tₚ\∪ᵣ₌₀ⁱ⁻¹A_{r,p} and placing the at most ┌|Tₚ|/kₚ┐ adjacent vertexes into the set A_{i,p},
┌|Tₚ|/kₚ┐ representing rounding up |Tₚ|/kₚ.

20. The non-transitory computer-readable storage medium according to claim 15, wherein the performing qubit mapping on a logic circuit based on the at least two connected subgraphs, to obtain a hardware compilable circuit equivalent to the logic circuit comprises:
permuting a first quantity of logic bit pairs in the logic circuit based on the at least two connected subgraphs, the first quantity being a quantity of edges comprised in the maximum matching of the coupling graph, and each logic bit pair corresponding to two qubits on which one two-qubit gate acts in the logic circuit;
generating a first portion of the hardware compilable circuit corresponding to the first quantity of logic bit pairs;
permuting remaining logic bit pairs in the logic circuit based on the at least two connected subgraphs;
generating a second portion of the hardware compilable circuit corresponding to the remaining logic bit pairs; and
obtaining the hardware compilable circuit equivalent to the logic circuit based on the first portion of the hardware compilable circuit and the second portion of the hardware compilable circuit.
